(19) United States
(12) Patent Application Publication
(10) Pub. No.: US 2008/0137609 A1
(43) Pub. Date: Jun. 12, 2008

(54) Systems and methods for increasing mobility in fixed wideband wireless applications

(75) Inventors: Heng Pan, Shanghai (CN); Shuxin Liu, Shanghai (CN)

Correspondence Address: FULBRIGHT & JAWORSKI L.L.P, 2200 ROSS AVENUE, SUITE 2800, DALLAS, TX, 75201-2784, US

(73) Assignee: Adaptix, Inc., Seattle, WA (US)

(21) Appl. No.: 11/651,240

(22) Filed: Jan. 9, 2007

(30) Foreign Application Priority Data
Dec. 8, 2006 (CN) 200610162065.1

(51) Int. Cl. H04Q 7/00

(52) U.S. Cl. 370/331; 370/328

(57) ABSTRACT

By arranging base stations in a wireless protocol with an ability to handle air interface transmissions on a class of service basis, as opposed to a specific station identification basis, mobility across base stations is achieved. In one embodiment, each station is assigned a class of service and each station can connect to any base station that recognizes that station's class of service. Class of service could, for example, be based on throughput required, fees paid by the station, etc. In this manner, the base station need only know the class of service of a station and then can extend service to that station or not based on factors controlled from each base station. In one embodiment, the class of service information provided with the 802.16f management model is used to verify the class of service of a station and to update base stations.

### RELATED APPLICATIONS

This application is related to and claims priority to Chinese Application No. 200610162065.1 filed Dec. 8, 2006 entitled “SYSTEMS AND METHODS FOR INCREASING MOBILITY IN FIXED WIDEBAND WIRELESS APPLICATIONS”, the disclosure of which is hereby incorporated herein by reference.

### TECHNICAL FIELD

This invention relates to wireless applications and more specifically to systems and methods for increasing mobility in fixed wideband applications and even more particularly to such systems and methods for use with the 802.16e protocol.

### BACKGROUND OF THE INVENTION

The 802.16f management model for use in some air interface situations requires that a base station have contained therein (perhaps in a lookup table) information (such as the SS identification of the station) pertaining to all mobile stations that can be connected to that base station. Such a requirement does not work well since as mobility increases, the frequency with which a given base station is called upon to connect with stations that are not pre-known also increases. Short of providing every base station with information pertaining to every possible using station, the protocol for 802.16f is not suitable for general air interface communication, such as is desired with 802.16e equipped devices. To put it in other terms, the existing 802.16f model is not universally scalable and is thus used in a fixed situation where the base station always interacts with the same known stations and the stations always interact with the same base station.

Since the protocol assumes a fixed relationship, there is no provision for handing-off between base stations or for “roaming”. Thus, while the protocol functions well for fixed environments, it is inadequate to handle mobility of stations across base stations.

### BRIEF SUMMARY OF THE INVENTION

By arranging base stations in a wireless protocol with an ability to handle air interface transmissions on a class of service basis, as opposed to a specific mobile station identification basis, mobility across base stations is achieved. In one embodiment, each station is assigned a class of service and each station can connect to any base station that recognizes that station's class of service. Class of service could, for example, be based on throughput required, fees paid by the station, etc. In this manner, the base station need only know the class of service of a station and then can extend service to that station or not based on factors controlled from each base station. In one embodiment, the class of service information provided with the 802.16f protocol is used to verify the class of service of a mobile station and to update base stations. In one embodiment, the base station can share in fees paid by the station for the privilege of obtaining a certain class of service.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of a system using the concepts of the present invention;

FIG. 2 shows one management model structure for facilitating the class of service configuration; and

FIG. 3 shows one embodiment of a method of enabling mobility using the protocol of FIG. 2.

### DETAILED DESCRIPTION OF THE INVENTION

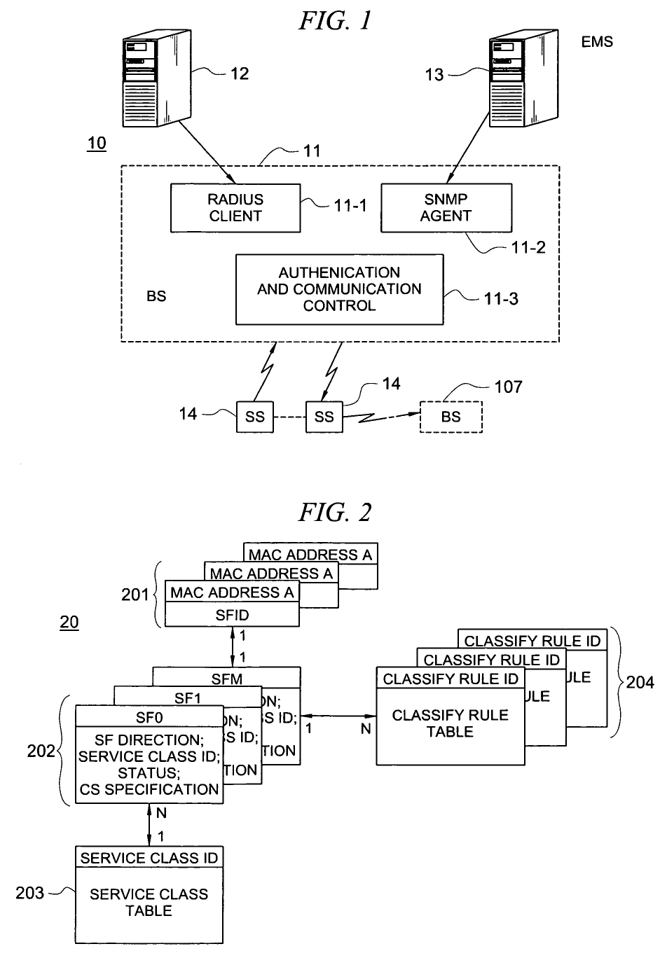

FIG. 1 shows one embodiment of system 10 using the concepts of the present invention. In the embodiment illustrated, wireless mobility is accomplished for the 802.16e protocol using the maximum model of the 802.16f protocol. As shown in FIG. 1, base station (BS) 11 comprises various portions, some of which are radius client 11-1 on the BS, SNMP agent 11-2 and authentication and communication control 11-3.

Stations 14 can connect to a base station, as will be discussed, based, at least in part, on the particular station's class of service which then will be authenticated for a particular base station by that base station's authentication and communication control 11-3. Note that one or more of mobile stations 14 could connect to BS 101 again depending upon class of service and signal quality received from BS 101. Any number of base stations can thus be served by the concepts discussed with respect to FIG. 1.

Radius server 12 is one example of a server for keeping track of class of services of the mobile stations that are attached to the network. The radius server can be accessed as needed from the base station via the radius client located at the base station. In a preferred embodiment, authentication and control 11-3 receives identity and security information from a calling mobile station and then forwards the information to the authentication server (radius server). The authentication is done by that server remote from the base station and the class of service of the calling mobile station is returned to the base station so that the base station can determine what it will do with respect to the calling mobile station based on rules contained at the base station.

After authentication, the server returns a set of parameters which the base station then uses for facilitating the air interface with the calling mobile station. The parameters include the class of service of the calling station and other common parameters, such as a master key (MSK). Based on the determined class of service of the calling station, bandwidth, for example, could be allocated.

If desired, the calling station can be informed by authentication and communication control 11-3 as to what the calling mobile station's “rights” are so that the station does not try to use features it is not entitled to with respect to this base station. In this manner, if desired, certain stations can have individual (or group) profiles valid with a select set (or one) base station.

Note that while a radius server is shown, any type of authentication can be employed, such EAP-AKA. Thus, in operation, when the subscriber station contacts the base station it identifies itself and, if required, enters a password, etc. The base station passes that information up to the authentication server. The authentication server goes through its data base routine and responds with a reject or accept message based on the parameters received from the calling station. In some systems, the parameters would map to a class of service as discussed herein. In other systems (or for some base stations) this might be a quality of service indication or some other parameter pertaining to a wide grouping of mobile stations (as opposed to an individual mobile station).

Once the base station has determined the class of service, or other parameter pertaining to permission level, the base station then uses a look-up table populated, for example, by EMS server 13. These classes are provisioned by the EMS server and are stored at the base station in a local look-up table, such as the SNMP MIB.

Some base stations may be community towers with high throughput capability and other base stations could be small private systems with limited capabilities. Thus, the actual features and/or bandwidth may be different at different base stations even for stations having the same class of service classification, if the service policy allows.

FIG. 2 shows one protocol structure 20 for facilitating the class of service configuration. Structure 20 is based on the 802.16f protocol and includes MAC address tables 201, service flow tables 202, service class table 203 and classifier rule tables 204. These tables can reside on the base station but instead of having a look-up for each possible mobile station in the system the look-up is based on a common set of parameters (in one example, the class of service). Thus, once the mobile station is identified to the base station, the base station becomes responsible for the control of the air interface between the base station and the identified mobile station all based upon a parameter carried by the connected mobile station where the parameter (and not the individual station) carries a set of operational rules.

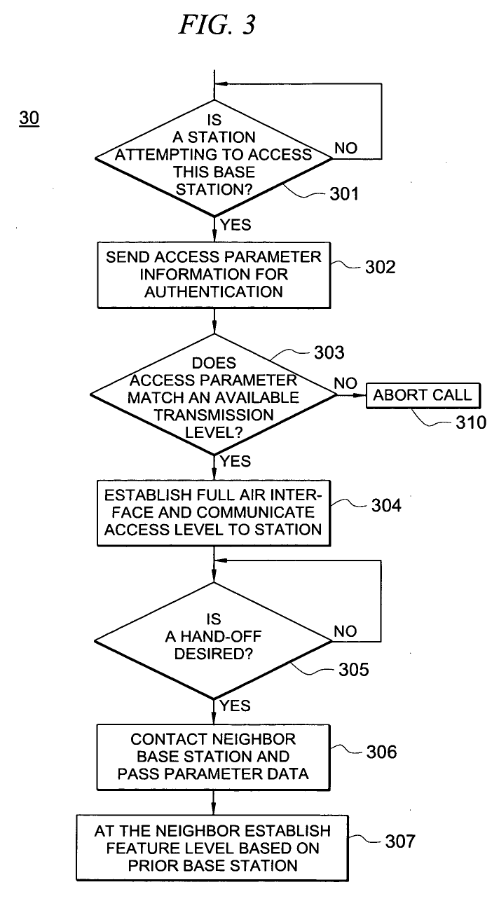

FIG. 3 shows one embodiment of a method of enabling mobility using the protocol of FIG. 2. Process 301, as discussed above, determines if an accessing (calling) mobile station is attempting to attach to the base station. When such an attempt is detected by a base station that base station then, in one embodiment, passed the identity and security information, process 302, along to an authentication server. The server then returns a set of operational rules including the class of service of the calling station and process 303, at the base station determines the appropriate action to take with respect to the calling station.

If the class of service of the calling station is not appropriate for this base station, process 310 so informs the calling mobile station and the air interface is aborted.

However, if transmission capability is available the full data transmission air interface is established (or continued) and the station, if desired, is informed via process 304 as to the services its class of service (or other access parameter) will allow at this base station and bi-directional communication can go forward using the bandwidth and other limitation appropriate to this base station and to this class of service access parameter.

Process 305 determines if a hand-off is required and/or desired by either the base station or the station. If so, process 306 contacts one or more neighbors and facilitates the hand-off, for example by passing along the determined class of service of the connected station, without again requiring a new class of service look-up. At the receiving base station the policies with respect to the station would be in accordance with the target base station's policies for this class of service and would not necessarily be the same as it was with the original base station. Process 307 optionally can upgrade or otherwise change the features given to a “transferee” based, at least in part, on the previous base station.

Note that while not necessary, operational rules can be encrypted for privacy purposes and for security of the system. The security keys and other data can then be transmitted between base stations and can thus reduce set-up time for a given session when stations are moving among different base stations. Also note that on a hand-off situation (or in any other desired situation), a receiving base station could, if it elected to do so, increase its “normal” transmission features (e.g., bandwidth) to accommodate certain stations. This accommodation can be because the receiving base station is being “nice”, or because of a prior arrangement with another base station for certain hand-offs. For example, during a voice call it might be desirable to be able to hand the call from base station to base station on an “accommodation” basis just to preserve the ability to make such voice calls.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of allowing a station to transfer data across a broadband wireless interface using the 802.16 protocol; said method comprising:
establishing a wireless link between a particular station and a particular one of a plurality of base stations, said wireless link being limited to the transmission of limited data between said particular station and said particular base station; and
allowing data transfer across said wireless link based upon a class of service of said particular station being acceptable to said particular base station.

2. The method of claim 1 further comprising:
updating class of service information, from time to time, to said base stations.

3. The method of claim 1 further comprising:
handing off said particular station from said particular base station to another one of said plurality of base stations, said handing off controlled, at least in part, by said class of service of said particular station.

4. The method of claim 3 wherein said class of service is passed from said particular base station to said another base station.

5. The method of claim 4 wherein said another base station assigns a level of service based, at least in part, on the identity of said particular base station.

6. The method of claim 4 wherein an assigned level of service to said at said another base station is an upgraded class of service.

7. The method of claim 1 further comprising:
informing said particular station of its data transferring features with respect to said particular base station.

8. A wireless broadband base station comprising:
a memory for storing therein class of service information pertaining to class of service profiles of stations that could be connected across an air interface with said base station; and
means for granting certain stations access across said air interface, said granting based, at least in part, on a class of service assigned to said station.

9. The base station of claim 8 further comprising:
means for updating said stored class of service information.

10. The base station of claim 8 wherein said granting means comprises at least portions of the 802.16f protocol.

11. The base station of claim 8 further comprising:
means, based at least in part on said class of service of a station currently connected across said air interface, for handing-off said wireless interface connection to another base station.

12. The base station of claim 11 wherein said handing-off means comprises a communication of said class of service of said station to said another base station.

13. The base station of claim 11 further comprising:
means for upgrading said particular station's transmission features based, at least in part, on the fact of a hand-off from another base station.

14. The base station of claim 13 wherein said transmission features of said upgrading means includes the identity of a transferring base station.

15. The base station of claim 8 wherein said access granting means comprises:
means for informing said particular station as to the transmission features allowed by said particular base station to said particular station.

16. A base station adapted for 802.16e wireless transmission and using the 802.16f protocol, said base station comprising:
a memory for storing therein transmission rules for a polarity of service classes pertaining to stations which can access said base station;
authentication control for receiving from an accessing station a class of service pertaining to said accessing station; and
said accessing control further operable for determining the class of service of said accessing station and for granting to said accessing station certain rights depending, at least in part, on said determined class of service.

17. The base station of claim 16 wherein at least a portion of said class of service determining occurs remote from said base station.

18. The base station of claim 16 wherein said accessing control further comprises message sending apparatus for communicating features to said station.

19. The base station of claim 16 further comprising apparatus for communicating class of service information to another base station.

20. The base station of claim 16 wherein said accessing control is further operable for upgrading features for a particular station depending, at least in part, to a prior connection of said particular station to another base station.
